(19) United States
(12) Patent Application Publication
(10) Pub. No.: US 2012/0131851 A1
(43) Pub. Date: May 31, 2012

(54) PLANTER SLIP-COVER

(76) Inventors: James Bell, Prescott, MI (US); Naomi Bell, Prescott, MI (US)

(21) Appl. No.: 12/955,901

(22) Filed: Nov. 29, 2010

(51) Int. Cl. A01G 9/02

(52) U.S. Cl. 47/72

(57) ABSTRACT

The present invention discloses a planter slip-cover to provide a decorative covering around a planter or pot while offering structural support to the planter base and top edge. The planter slip-cover comprises a sleeve extending vertically around an outer surface of a planter, a bottom plate located at a lower portion of the sleeve, where the bottom plate rests beneath a base of the planter, a lip located at an upper portion of the sleeve, where the lip fits around a top edge of the planter, and a set of perforated flanges affixed within the lip wherein the set of perforated flanges are removed individually to create a customized fit around the top edge of the planter.

### BACKGROUND OF THE INVENTION

1. Field of the Invention

The present invention discloses a planter slip-cover to provide a decorative covering around a planter or pot while offering structural support to the planter base and top edge.

2. Description of Related Art

Planting pots are available in a variety of sizes and materials. For example, some pots are circular, square or rectangular. Similarly, most of the pots are made out of ceramic, wood, plastic or terracotta. A problem with these materials is that they are often fragile and are easily broken. The cost of replacement can be expensive, and the task of plant relocation is tedious and labor intensive. Additionally, some people want to have a decorative planter to beautifully display their plants. The options available to a person for decorative pots are often limited and many times the person must paint or decorate their own pots.

U.S. Patent Application No. 2006/0179713 by Virginia Rose Smith Roberts discloses a Plant Cover wherein a covering is disclosed to wrap around a planter. The covering is an elongated piece of material wrapped around an outer surface of the planter, and the ends of the material overlap to secure the covering in place. The covering is reversible thus providing the planter with two decorative surfaces. While this covering offers a decorative surface the device serves merely an ornamental purpose.

It would be beneficial in the art to provide a planter cover that is not only aesthetically pleasing but is also supportive to the interior planter. It would also be desirable to have a covering that provides a customized fit around the planter.

### SUMMARY OF THE INVENTION

An object of the present invention is to provide a planter slip-cover to slide around a planter wherein the planter slip-cover includes a rigid bottom plate to support the base of the planter. Likewise, the planter slip-cover includes an adjustable lip to securely fit around a top edge of the planter.

In view of the foregoing disadvantages inherent in the prior art, the general purpose of the present disclosure is to provide a planter slip-cover comprising a sleeve extending vertically around an outer surface of a planter, a bottom plate located at a lower portion of the sleeve, where the bottom plate rests beneath a base of the planter, a lip located at an upper portion of the sleeve, where the lip fits around a top edge of the planter, and a set of perforated flanges affixed within the lip wherein the set of perforated flanges are removed individually to create a customized fit around the top edge of the planter.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a planter slip-cover in accordance with an exemplary embodiment of the present invention; and

FIG. 2 depicts a topside view of a planter slip-cover in accordance with an exemplary embodiment of the present invention.

Like reference numerals refer to like parts throughout the description of several views of the drawings.

### DETAILED DESCRIPTION OF THE DRAWINGS

The present invention relates to a cover to place around a planter to create a decorative surface for the planter. The present invention discloses a planter slip-cover to provide a reversible covering with a supportive bottom plate to allow for easy covering and replacing of traditional planter pots. The planter slip-cover supports the planter at its base, and allows for an adjustable top portion to enable plant growth within the planter.

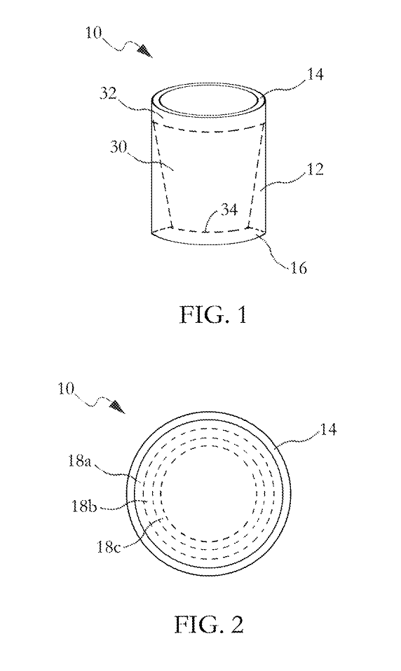

Turning now descriptively to the drawings, referring to FIG. 1, a perspective view of a planter slip-cover (10) is shown in accordance with an exemplary embodiment of the present invention. The planter slip-cover (10) may comprise a sleeve (12) with a generally tubular shape. The sleeve (12) extends vertically between a bottom plate (16) at a lower portion and a lip (14) at an upper portion to fit around a planter (30). The shape of the sleeve (12) may be cylindrical (as shown) or rectangular in cases when a square planter is used. The planter (30) includes an outer surface completely surrounded by the sleeve (12). The sleeve (12) may be colored or decorated with designs or patterns for a more aesthetic appearance, and to create a unique look for the outer surface.

The bottom plate (16) may be rigid to maintain a coordinating shape to the shape of the sleeve (12), such as circular for a cylindrical sleeve to accept a circular based planter or square for a rectangular sleeve to accept a cubed planter. A rigid bottom plate (16) may enable the planter (30) to be transported while being supported at its base (34). Likewise, the bottom plate (16) may be rubberized to offer cushioning to the base (34) and to minimize planter (30) breakage and damage. The bottom plate (16) may alternatively be soft to accept a variety of different planters (30).

At the top portion of the sleeve (12) the lip (14) may encircle a top edge (32) of the planter (30). The lip (14) may wrap inwardly around the top edge (32) to create a tight and secure fit upon the planter (30). Within the lip (14) may be a piece of elastic to enable the lip (14) to hold a tight yet adjustable grip around the upper edge (32).

The sleeve (12) may be made from a flexible or waterproof fabric including nylon, spandex, neoprene, canvas, rubber or plastic. The more flexible fabrics like spandex and nylon may have a waterproof lining to ensure that water does not pass through the material. The sleeve (12) may be reversible to allow two different colors, patterns or designs to be used to decorate the outer surface of the planter (30).

Referring now to FIG. 2, a topside view of the planter slip-cover (10) is shown in accordance with an exemplary embodiment of the present invention. The lip (14) is illustrated completely surrounding the top edge of the planter. Creating circular segments within the lip (14) may be a set of perforated flanges (18a, 18b, 18n). The set of perforated flanges (18a, 18b, 18n) enable the lip (14) of the planter slip-cover (10) to fit securely around planters with openings of varying sizes. The set of perforated flanges (18a, 18b, 18n) may allow a more customized fit around the top edge (32) of the planter (30).

For use, a user slides the planter (30) within the sleeve (12). Then, depending on the size of the top edge (32) of the planter (30), the user may simply tear away on of the perforated flanges (18a, 18b, 18n) starting with the central perforated flange (18n). The user may continuously remove the next flanges (18a, 18b) until a circumference is reach to match the top edge (32) of the planter (30). Alternatively, the user may remove the perforated flanges (18a, 18b, 18n) until enough room for a plant is attained. As the plant grows, more perforated flanges (18a, 18b, 18n) may be removed.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A planter slip-cover comprising:
a sleeve extending vertically around an outer surface of a planter;
a bottom plate located at a lower portion of said sleeve, where said bottom plate rests beneath a base of said planter;
a lip located at an upper portion of said sleeve, where said lip fits around a top edge of said planter; and
a set of perforated flanges affixed within said lip wherein said set of perforated flanges are removed individually to create a customized fit around said top edge of said planter.

2. The planter slip-cover of claim 1, wherein said planter slip-cover is reversible.

3. The planter slip-cover of claim 1, wherein said sleeve is made from a flexible material.

4. The planter slip-cover of claim 1, wherein said bottom plate is rigid to support said base.

5. The planter slip-cover of claim 1, wherein said sleeve is cylindrically shaped with a circular lip and a circular base.

6. The planter slip-cover of claim 1, wherein within said lip is a piece of elastic to tightly fit around said top edge of said planter.

7. The planter slip-cover of claim 1, wherein said sleeve has a rectangular shape with a square base and a square lip.

8. The planter slip-cover of claim 1, wherein said set of perforated flanges tear away to fit around a plant within said planter.
